(19) United States
(12) Patent Application Publication
(10) Pub. No.: US 2026/0185893 A1
(43) Pub. Date: Jul. 2, 2026

(54) A REAL-TIME MONITORING LEAK DETECTION SYSTEM AND REAL-TIME DISTRIBUTION UNIFORMITY MEASUREMENT

(71) Applicant: Mehmet Atif COKA, ISTANBUL (TR)

(72) Inventor: Mehmet Atif COKA, ISTANBUL (TR)

(21) Appl. No.: 19/002,201

(22) Filed: Dec. 26, 2024

(51) Int. Cl. G01M 3/28; G08B 21/18; H04W 4/38

(52) U.S. Cl. CPC G01M 3/2815; G08B 21/182; H04W 4/38

(57) ABSTRACT

Disclosed herein is a real-time monitoring and leak detection system for lateral irrigation pipes, which is pre-manufactured with embedded sensors and also has removable sensors.

### FIELD OF THE DISCLOSURE

The present disclosure is related to a real-time monitoring and leak detection system for lateral irrigation pipes, which is pre-manufactured with embedded sensors and also has removable sensors.

### BACKGROUND

Irrigation systems play a very critical role in modern agriculture to ensure efficient water use and crop health. However, issues such as undetected leaks, uneven/inconsistent water distribution, inefficient resource use, and improper pressure regulation are important problems for these irrigation systems. Such problems lead to significant water wastage and reduced agricultural productivity.

Existing irrigation systems rely on external (removable) sensors for measuring of pressure or other parameters but these systems frequently have complex installations, manual monitoring/inspections or significant infrastructure modifications, which lead to inefficiencies, higher costs, time-consuming and errors.

In US2020080875 (A1), systems and methods for irrigation monitoring and leak detection are proposed and outlined as “the methods comprise: using a micro-turbine and an Energy Harvesting Circuit (“EHC”) to harvest energy from a fluid flowing through a pipeline; operating a switch to disconnect the EHC from the micro-turbine when an amount of energy harvested reaches a threshold value; detecting by a sensor device an amount of natural fluid flow through the pipeline while the EHC is disconnected from the micro-turbine; and operating the switch to reconnect the EHC to the micro-turbine after the amount of natural fluid flow has been detected.”

Also, US2018164179 (A1) is about leak detection in irrigation systems which is summarized as “a device can receive, from a set of sensor devices associated with an irrigation system, information that identifies a set of volumetric flow rates. The device can determine a set of pressure loss values based on the set of volumetric flow rates. The device can determine, based on the set of pressure loss values and a first set of moving average pressure loss values, a second set of moving average pressure loss values. The device can determine a subset of sensor devices for which corresponding moving average pressure loss values satisfy a threshold, and determine a subset of locations that correspond to the subset of sensor devices. The device can identify a leak location based on the subset of locations, and provide information that identifies the leak location to permit and/or cause an action to be performed in association with the leak location.”

US2015289460 (A1) mentions an automated plant irrigation method and system using weight and leak sensors and its abstract is as follows: “embodiments of the disclosed technology are directed to methods, systems, and/or apparatuses for monitoring and maintaining hydration levels in plants. The technology employs a base onto which a plant is placed. The base may have a built-in scale, as well as a spout for dispensing water. The spout may be coupled to a water supply via a pump. The scale may be coupled to a processor used to weigh the plant, detect fluctuations in weight, and/or to initiate/cease dispensing of water to the plant based on detected parameters. A leak sensor may also be incorporated into the spout for cutting off the water supply upon detection of possible over-watering. The base may also have an input for facilitating user control over the irrigation frequency and dosage.”

Also US2011232770 (A1) and US2006202051 (A1) further set forth known technology.

### SUMMARY

The present disclosure relates to a real-time monitoring and leak detection system that eliminates the disadvantages of conventional systems and brings some additional advantages.

One aim of at least one embodiment of the invention is to provide a real-time monitoring and leak detection system for lateral irrigation pipes, which is pre-manufactured with embedded sensors and also has removable sensors.

Another aim of at least one embodiment of the invention is to provide a real-time monitoring and leak detection system that ensures efficient water consumption.

Another aim of at least one embodiment of the invention is to provide a real-time monitoring and leak detection system that obstructs undetected leaks, uneven/inconsistent water distribution, inefficient resource consumption, improper pressure regulation, significant water waste, and reduced agricultural productivity.

Another aim of at least one embodiment of the invention is to provide a real-time monitoring and leak detection system that has embedded sensors and optionally has removable sensors on lateral irrigation pipes to take advantage of both. By this adaptable method, external attachments like additional/removable sensors turn into an option not an obligation.

Another aim of at least one embodiment of the invention is to provide a real-time monitoring and leak detection system that is simple to install and modify.

Another aim of at least one embodiment of the invention is to provide a real-time monitoring and leak detection system that has automatic monitoring/inspections.

Another aim of at least one embodiment of the invention is to provide a real-time monitoring and leak detection system that has different sensor options like pressure, pH, temperature, and waterflow.

Another aim of at least one embodiment of the invention is to provide a real-time monitoring and leak detection system that has sustainability and durability properties because of the embedded sensors.

Another aim of at least one embodiment of the invention is to provide a real-time monitoring and leak detection system that can collect data (e.g., water pressure data) continuously.

Another aim of at least one embodiment of the invention is to provide a real-time monitoring and leak detection system that can guarantee distribution of the water uniformly because of permanent leak detection.

Another aim of at least one embodiment of the invention is to provide a real-time monitoring and leak detection system that has a simple maintenance period because of the removable sensors.

Another aim of at least one embodiment of the invention is to provide a real-time monitoring and leak detection system that is cost-effective by reducing the operational costs.

Another aim of at least one embodiment of the invention is to provide a real-time monitoring and leak detection system that can give immediate feedback via a central server.

Another aim of at least one embodiment of the invention is to provide a real-time monitoring and leak detection system that can work with both drip and sprinkler irrigation elements.

Another aim of at least one embodiment of the invention is to provide a real-time monitoring and leak detection system that eliminates cables/cabling.

### BRIEF DESCRIPTION OF THE DRAWINGS

In order to best understand the structure of the present invention and its advantages together with the additional elements, it should be evaluated together with the figures explained below.

FIG. 1 shows a representative view of the real-time monitoring and leak detection system that is the subject of at least one embodiment of the invention for use in sprinkler irrigation.

FIG. 2 shows a representative view of the real-time monitoring and leak detection system that is the subject of at least one embodiment of the invention for use in drip irrigation.

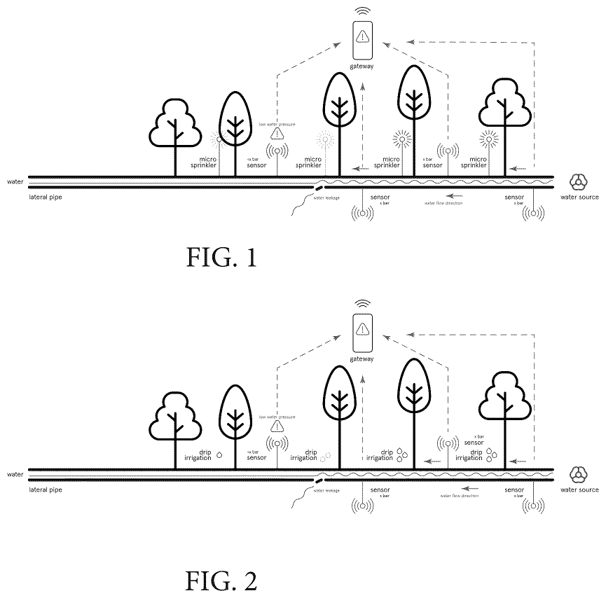

### REFERENCE NUMBERS

1. Water Source
2. Embedded Sensor
3. Removable Sensor
4. Micro Sprinkler
5. Drip
6. Gateway
7. Pipe
8. Communication Network
9. Server
10. Database
11. Software

### DETAILED DESCRIPTION

A real-time monitoring and leak detection system and/or its preferred embodiments are explained below only for the purpose of a better understanding of the subject and in a way that does not create any limiting effect.

In at least one embodiment, a real-time monitoring and leak detection system is disclosed for lateral irrigation pipes (7) that carry water from a water source (1). The system involves embedded sensors (2) placed internally within the mentioned lateral irrigation pipes (7) during manufacturing to measure the water pressure, a server (9) that collects the real time water pressure data from the mentioned embedded sensors (2), and a communication network (8) that provides data transmission from the mentioned embedded sensors (2) to the server (9).

The embedded sensors (2) may be integrated directly into the pipe (7) material or structure and they (2) are placed at strategic intervals/points on the pipe according to irrigation field.

Thus, the embedded sensors (2) are durable and long-lived against agricultural conditions and they (2) can resist environmental factors such as damage, UV exposure, soil contact, and moisture. This pre-manufactured operation reduces installation complexity.

Preferably, a database (10) is assigned to keeps all data for the system in the server (9). The mentioned communication network (8) could be any one of: a wireless Internet (Wi-Fi) network, a Long Range Wide Area Network (LoRaWAN), or an Internet of Things (IoT) network. By using a wireless communication network (8), efficient long-range data transmission is easily available. In a non-limiting example, a gateway (6) can be used that enables the communication network's (8) operation.

Also, the system may contain removable sensors (3), which are externally attachable and detachable to the mentioned lateral irrigation pipes (7) for measuring the water pressure and transmitting real-time water pressure data to the server (9) via the mentioned communication network (8). Removable sensors (3) may be designed to attach externally to the lateral irrigation pipes (7) using secure clamps or adhesive mechanisms to provide flexible modification.

The mentioned sensors (2,3) can measure flow and/or temperature and/or pH of the water as well as the pressure of the water. They (2, 3) also have antennas to send real-time pressure data to the mentioned server (9) and a controller that coordinates and audits real-time pressure data of the mentioned sensors (2,3).

The real-time monitoring and leak detection system may also include software (11) that checks whether the real-time pressure data received from each of the embedded sensors (2) falls below a predetermined value. The software (11) can analyze and visualize all the flow using the sensors' (2,3) data. The software (11) can also immediately detect leaks, distribution inconsistencies, and pressure anomalies using a mapping function across the irrigation line(s).

The mentioned software (11) also checks whether the real-time pressure data received from each sensor (2, 3) are at the same value for distribution uniformity of the water and provides an alert or informational message (e.g., a text or SMS message, computer and/or mobile application notification, electronic mail message (e-mail), etc.) when the pressure value from sensors (2, 3) falls below a predetermined pressure value and/or when different pressure values are read from the sensors (2, 3).

If needed, a compressor that presses the water to the mentioned lateral irrigation pipes (7) and a valve that directs the water in the mentioned pipes (7) could also be used in the irrigation plumbing line.

1. A real-time monitoring and leak detection system for lateral irrigation pipes that carry water from a water source, comprising:
embedded sensors placed internally within a material and/or structure of the lateral irrigation pipes during manufacture of the lateral irrigation pipes, to measure water pressure in the lateral irrigation pipes,
a server that collects, from the embedded sensors in real time, a first set of water pressure data, the first set of water pressure data comprising individual data from each of the embedded sensors,
a communication network that transmits the first set of water pressure data from the embedded sensors to the server, and
at least one computing device having at least one processor operatively connected to at least one non-transitory computer readable storage medium, the at least one non-transitory computer readable storage medium having computer-executable instructions stored thereon, which, when executed by the at least one processor, cause the at least one processor to execute operations comprising:
determining whether the individual data from each of the embedded sensors falls below a predetermined value.

2. The real-time monitoring and leak detection system according to claim 1, wherein the operations further comprise:
determining whether the individual data from each of the embedded sensors are at a same value for uniform distribution of the water.

3. The real-time monitoring and leak detection system according to claim 2, wherein the operations further comprise:
transmitting an alert when the value falls below the predetermined pressure value and/or when the individual data from each of the embedded sensors are not at the same value.

4. The real-time monitoring and leak detection system according to claim 1, wherein the embedded sensors comprise antennas to send the first set of water pressure data to the server.

5. The real-time monitoring and leak detection system according to claim 1, further comprising a controller that coordinates and audits the first set of water pressure data.

6. The real-time monitoring and leak detection system according to claim 1, wherein the embedded sensors measure flow of the water, temperature of the water, and/or pH of the water.

7. The real-time monitoring and leak detection system according to claim 1, further comprising:
removable sensors that are attachable and detachable to an external surface of the lateral irrigation pipes to measure the water pressure and to transmit, via the communication network, a second set of water pressure data to the server, the second set of water pressure data comprising individual data from each of the removable sensors.

8. The real-time monitoring and leak detection system according to claim 7, wherein the operations further comprise:
determining whether the individual data from each of the removable sensors are at a same value for uniform distribution of the water.

9. The real-time monitoring and leak detection system according to claim 8, wherein the operations further comprise:
transmitting an alert when the same value falls below a predetermined pressure value and/or when the individual data from each of the removable sensors are not at the same value.

10. The real-time monitoring and leak detection system according to claim 7, wherein the removable sensors comprise antennas to send the second set of water pressure data to the server.

11. The real-time monitoring and leak detection system according to claim 7, further comprising a controller that coordinates and audits the second set of water pressure data.

12. The real-time monitoring and leak detection system according to claim 7, wherein the removable sensors measure flow of the water, temperature of the water, and/or pH of the water.

13. The real-time monitoring and leak detection system according to claim 1, wherein the operations further comprise:
mapping the lateral irrigation pipes.

14. The real-time monitoring and leak detection system according to claim 1, wherein the communication network is any one of: a wireless Internet (Wi-Fi) network, a Long Range Wide Area Network (LoRaWAN), or an Internet of Things (IoT) network.

15. The real-time monitoring and leak detection system according to claim 1, further comprising a gateway that enables operation of the communication network.

16. The real-time monitoring and leak detection system according to claim 1, further comprising a database for storing the first set of water pressure data.

17. The real-time monitoring and leak detection system according to claim 1, further comprising a compressor that pressurizes the water to the lateral irrigation pipes.

18. The real-time monitoring and leak detection system according to claim 1, further comprising a valve that directs the water in the lateral irrigation pipes.
